(19) United States
(12) Patent Application Publication
(10) Pub. No.: US 2004/0228614 A1
(43) Pub. Date: Nov. 18, 2004

(54) Recording medium, image recording apparatus and image recording method

(75) Inventors: Masanori Yokoyama, Tokorozawa-shi (JP); Shunsuke Shibusawa, Tokyo (JP); Kiyoshi Minamisawa, Sagamihara-shi (JP); Tsyuoshi Haraguchi, Tokyo (JP); Katsutoshi Iwai, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/841,630

(22) Filed: May 10, 2004

(30) Foreign Application Priority Data
May 14, 2003 (JP) JP2003-136502

(51) Int. Cl. H04N 5/783; G03B 7/24

(52) U.S. Cl. 386/69; 386/95

(57) ABSTRACT

A recording medium set comprising: a plurality of recording media for recording a plurality of images; and a recording medium set for recording the thumbnails of the pluriality of images and storage information of the plurality of images in mutually associated form; an image recording apparatus comprising; an image recording section for recording a plurality of images on a plurality of recording media; and a storage information recording section for recording the thumbnails of the aforementioned plurality of images and storage information of the aforementioned plurality of images in mutually associated form; and an image recording method implemented by the aforementioned image recording apparatus.

### BACKGROUND OF THE INVENTION

The present invention relates to a recording medium set, image recording apparatus and image recording method, particular to the recording medium set, image recording apparatus and image recording method suitable for storing many images on the recording medium such as CD-R.

In addition to the service of developing and printing a photographed image, laboratory services includes the services of recording the image data obtained by digitalization of a developed image, on the recording medium such as CD-R and offering the recorded medium to users.

In such services based on digital technologies, to ensure that a use can easily identify the image data recorded on the recording medium such as CD-R, Patent Document 1 proposes a recording medium writing apparatus for recording the original image data obtained from an image forming medium, on a recording medium in a predetermined file format. This recording medium writing apparatus comprises a first storage section for storing a plurality of the aforementioned original image data sets; a second storage section for storing a template for creating the aforementioned index image; a index image data creating section for creating an index image data by superimposing the thumbnail image data of each of the aforementioned plurality of original image data sets and the aforementioned thumbnail; and a write section for writing the aforementioned original image data an index image data in the aforementioned recording medium.

The recording medium created by this apparatus allows the original image data recorded on the recording medium to be identified, without the need of displaying the high-volume original image data recorded on the recording medium.

To search the recording media created by this apparatus, it is necessary to replace the recording media. When one wishes to manage a great number of images using recording media, much time must be spent to find out a required image in a particular recording medium.

[Patent Document 1]: Official Gazette of Japanese Patent Tokkai 2002-372755

### SUMMARY OF THE INVENTION

In view of the prior art described above, it is an object of the present invention to provide a recording medium set, image recording apparatus and image recording method that ensures easy image management in the case of managing a plurality of images by recording them on a plurality of recording media.

Another object of the present invention is to provide a recording medium set, image recording apparatus and image recording method that permit use of the recording media of various capacities as recording media.

A further object of the present invention is to provide a recording medium set, image recording apparatus and image recording method capable of automatic setting of the capacity of a recording medium used as such.

A still further object of the present invention is to provide a recording medium set, image recording apparatus and image recording method where the capacity of the recording medium used as such can be set by a user.

The above objects can be achieved by the following configuration and method:

(1) A recording medium where thumbnail data of a plurality of image data sets recorded on a plurality of recording media and storage information are stored on the memory of the image recording apparatus, and thumbnail data stored in this memory and storage information are recorded in a mutually associated form.

(2) An image recording apparatus where a plurality of image data sets are recorded on a plurality of recording media; thumbnails of a plurality of image data sets recorded on a plurality of recording media are stored in the memory; and the thumbnail data stored in this memory and the storage information on the plurality of image data sets are recorded in the recording medium in a mutually associated form.

(3) The image recording apparatus of (2) comprising a capacity acquisition section for acquiring capacity information of the recording medium for recording a plurality of images, wherein the aforementioned image recording section determines the capacity of images to be recorded for each recording medium, based on the capacity information acquired by the capacity acquisition section.

(4) The image recording apparatus of (3) wherein the capacity information of the recording medium is acquired by detecting the capacity of the first recording medium.

(5) The image recording apparatus of (3) wherein the aforementioned capacity acquisition section acquires the capacity information of the recording medium by accepting the user's settings.

(6) The image recording apparatus of (2), (3), (4) or (5) wherein the aforementioned image recording section contains an ID recording section for recording the ID information assigned to each recording medium, on the recording medium, and the storage information recorded by the aforementioned information recording section contains the ID information.

(7) An image recording method comprising:

a step of recording a plurality of image data sets on a plurality of recording media;

a step of storing the thumbnail data of a plurality of image data sets recorded on a plurality of recording media, in the memory; and

a step of recording the thumbnail data stored in this memory and the storage information on the plurality of image data sets, on the recording medium in a mutually associated form.

(8) The image recording method of (7) containing a capacity acquisition step of acquiring the capacity information of the recording medium for recording a plurality of images, wherein the aforementioned image recording step determines the capacity of images to be recorded for each recording medium, based on the capacity information acquired in the capacity acquisition step.

(9) The image recording method of (8) wherein the aforementioned capacity acquisition step acquires the capacity information of the recording medium by detecting the capacity of the first recording medium.

(10) The image recording method of (8) wherein the aforementioned capacity acquisition step acquires the capacity information of the recording medium by accepting the user's settings.

(11) The image recording method of (7), (8), (9) or

(10) wherein the image recording step contains an ID recording step for recording the ID information assigned to each recording medium, on the recording medium, and the storage information recorded in the aforementioned information recording step contains the ID information.

(12) An image forming system comprising:

an image recording apparatus where a plurality of image data sets are recorded on a plurality of recording media; thumbnails of a plurality of image data sets recorded on a plurality of recording media are stored in the memory; and the thumbnail data stored in this memory and the storage information on the plurality of image data sets are recorded in the recording medium in a mutually associated form; and

an image forming apparatus comprising:

a step of scanning the thumbnail data recorded on the aforementioned recording medium and storage information;

a step of displaying the aforementioned scanned thumbnail data and storage information;

a step of designating the recording medium with a desired image recorded thereon, based on the thumbnail data and storage information; and

a step of scanning the image from the designated recording medium and producing a printed output.

### BRIEF DESCRIPTION OF THE DRAWINGS

FIG. 1 is a functional block diagram representing an image recording apparatus;

FIG. 2 is a diagram representing an example of processing in the image recording apparatus;

FIG. 3 is a diagram representing an example of a printing apparatus applied to the recording medium set; and

FIG. 4 is a diagram representing an example of processing in the printing apparatus shown in FIG. 3.

### DETAILED DESCRIPTION OF THE PREFERRED EMBODIMENT

Referring to the drawings, the following describes the preferred embodiment of the present invention:

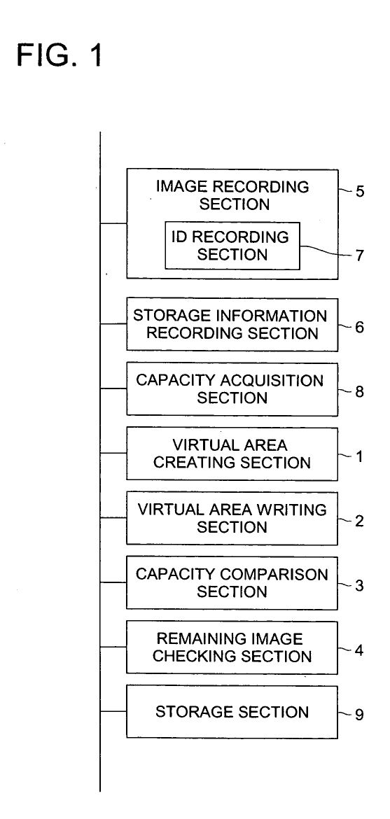

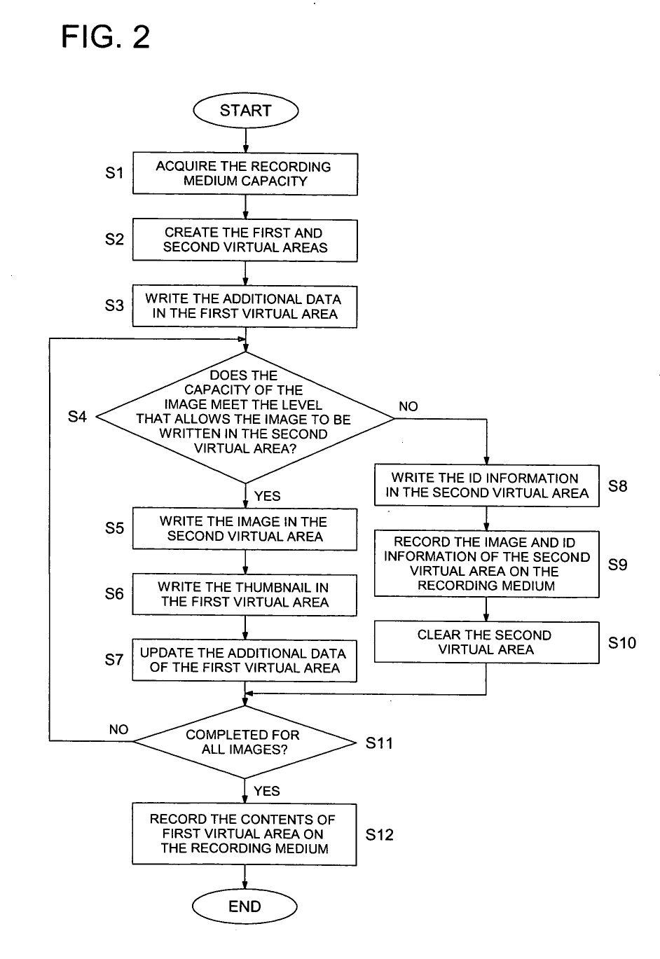

The following describes an example of an image recording apparatus for implementing the image recording method of the present invention, with reference to FIGS. 1 and 2:

FIG. 1 is a functional block diagram representing an image recording apparatus and FIG. 2 is a diagram representing an example of processing in the image recording apparatus of the present invention.

In FIG. 1, the image recording apparatus of the present invention contains a virtual area creating section 1, Virtual area writing section 2, capacity comparison section 3, remaining image checking section 4, image recording section 5, storage information recording section 6, and storage section 9, preferably as well as ID recording section 7 and capacity acquisition section 8.

The storage section 9 stores the image to be recorded and data other than actual image (hereinafter referred to as “additional data”). The image to be recorded herein may be called actual image as distinguished from the image such as thumbnail.

Any one of thumbnail, color management information, layout information, back print information, index print information, order information, trimming information and front print information, for example, can be adopted as the data other than the actual image.

Color management information includes information on image correction such as sharpness, color correction and density correction, for example. Layout information denotes image position when pluralities of images are present in one print. Back print information shows the item to be printed on the back. Index print information shows the format in which index printing is performed. Order information denotes details of print order such as the number of prints and print size. Trimming information denotes the way of trimming and rotating the image. The front print information shows such an item as a title and date that are synthesized and displayed on the surface of the print.

The virtual area creating section 1 creates a virtual area capable of recording various forms of digital data. The virtual area is a storage area virtually created in the recording apparatus inside the large-capacity image recording apparatus. The virtual area is provided with two virtual areas; a first and second virtual area areas.

The virtual area creating section 1 allows the capacity acquisition section 8 provided preferably to acquire the capacity information of the recording medium, so that the aforementioned two virtual areas can be provided to have the same capacity as that of the acquired capacity information.

Provision of the capacity acquisition section 8 permits the recording medium having a variety of capacities to be used as a recording medium.

Capacity information denotes the capacity of the recording medium (e.g. 700 MB, 650 MB).

The capacity acquisition section 8 has two modes; one is to acquire the capacity information of the recording medium by detecting the capacity of the first recording medium, and the other is to acquire the capacity information of the recording medium by accepting the user's settings.

The mode of acquiring by detecting the capacity information is advantageous in that the capacity is detected automatically without wasting user's time. The mode of acquiring by accepting the user's settings is preferred because reliable user setting can be ensured and data is not recorded to the full capacity of the recording medium.

The Virtual area writing section 2 allows the data other than actual image to be written in the first of the aforementioned two virtual areas, and permits the image stored in the storage section 9 to be written in the second one.

The Virtual area writing section 2 is capable of updating the data written in the first virtual area.

The capacity comparison section 3 compares between the capacity of the image to be written by the Virtual area writing section 2 and the free space of the second virtual area, and determines whether or not the capacity of the image to be written is smaller than the free space of the second virtual area.

The image recording section 5 records on the recording medium the image written in the second virtual area. It is preferred that recording be started when the capacity comparison section 3 has determined that the image capacity is not smaller than the free space of the virtual area. The image written in the second virtual area is deleted after it has been written on the recording medium by the image recording section 5. It is preferred that the image recording section 5 has an ID recording section 7, and record the ID information assigned to the recording medium.

The remaining image checking section 4 checks whether or not the image to be written still remains in the storage section 9.

The storage information recording section 6 writes into the recording medium the data other than the actual image written in the first virtual area. It is preferred that recording be started when the remaining image checking section 4 has determined that there is no image to be written. The data other than the actual image written in the first virtual area is deleted after it has been written on the recording medium by the remaining image checking section 4.

The following describes the flow of processing in the image recording apparatus of the present invention:

In FIG. 2, the capacity information of the recording medium is acquired by the capacity acquisition section 8 (S1).

The virtual area creating section 1 creates two virtual areas; first and second virtual areas (S2).

The additional data as the data other than actual data is written into the first virtual area by the Virtual area writing section 2 (S3).

The capacity comparison section 3 determines whether or not the image to be written can be written into the second virtual area (S4). If the image capacity to be written is smaller than the free space of the second virtual area, the image is written into the second virtual area by the Virtual area writing section 2 (S5). The thumbnail of this image is created and is written into the first virtual area by the Virtual area writing section 2 (S6). After that, the additional data of the first virtual area is updated. The additional data is updated by writing the information showing the ordinal position of the recording medium where the image has been recorded.

In S4, when the capacity comparison section 3 has determined that the capacity of the image data is greater than the free space of the second virtual area, ID information is written into the second virtual area by the Virtual area writing section 2 (S8), and the image and ID information of the second virtual area are recorded on the recording medium (S9). Then the second virtual area is cleared (S10). The ID information is the information to identify each of a plurality of recording media. For example, every time a new image is written into the second virtual area, the ID information is assigned to it as new information.

For example, if images are written into the recording medium when the number of the image sheets is 100 (23 MB for each sheet) and the capacity of the second virtual area is 700 MB, the capacity comparison section determines that the capacity is 690 MB if 30 sheets are written in the second virtual area, and the capacity of 700 MB is exceeded if another sheet is written (S4). Thus, the image written into the second virtual area is recorded on the recording medium together with the ID information (S9). Further, the data in the second virtual area is cleared (S10) and the 31st image is stored into the second virtual area.

After completion of processing in S7 and S10, the remaining image checking section 4 checks whether or not the image to be recorded still remains in the storage section 9 (S11). If there is still an image to be recorded, the system goes back to the processing of S4. If there is no such an image, the contents in the first virtual area are recorded into the recording medium by the storage information recording section 6 (S12).

A recording medium that is different for every recording is used as the recording medium to be recorded in the processing of S9. To put it another way, a plurality of the recording media recorded by the processing of S9 are created by the number of times recording is created.

As described above, the image recording apparatus of the present invention provides a recording medium set comprising a plurality of recording media recording a plurality of images, and recording media recording the thumbnail data of a plurality of images and storage information of the plurality of images in a mutually associated form.

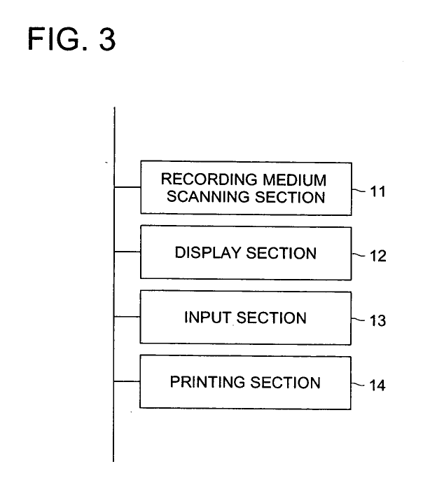

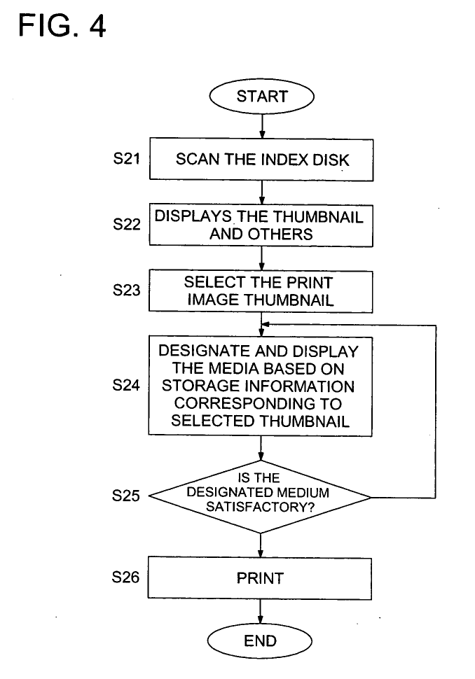

Referring to FIGS. 3 and 4, the following describes the processing to be applied when an image is printed using the recording medium set created by the image recording apparatus:

FIG. 3 is a diagram representing an example of a printing apparatus applied to the recording medium set.

FIG. 4 is a diagram representing an example of processing in the printing apparatus shown in FIG. 3.

As shown in FIG. 3, the printing apparatus capable of using the recording medium set of the present invention includes a recording medium scanning section 11 for scanning a recording medium; a display section 12 for giving a display so that it can be identified by users; an input section 13 for accepting the user's input; and a printing section 14 for printing an image whenever required.

In FIG. 4, of a plurality of recording media of the recording medium set, the recording medium (index disk) recorded in the processing of S12 in FIG. 2 is scanned by the recording medium scanning section 11 (S21).

The information such as thumbnail data recorded in the recording medium scanned in S21 is displayed on such a display section as a monitor screen (S22). In this case, in addition to the thumbnail data, any one of the color management information, layout information, back print information, index print information, order information, trimming information and front print information can be displayed.

A user selects an image to be printed, in the thumbnail screen. This selection is accepted by the input section 13 (S23).

The display section 12 gives a display to designate the recording medium based on the storage information corresponding to the selected thumbnail (S24).

The recording medium scanning section 11 verifies that scanning of the designated recording medium is enabled (S25). After that, the image is scanned from the recording medium and is printed by the printing section 14 (S26).

As described above, the image recording apparatus of the present invention provides a recording medium set that capable of printing a desired image by searching it from of all records even when a plurality of images are recorded on a plurality of recording media. This function ensures an easy search of an image when a large number of images recorded on a plurality of recording media are managed.

The present invention provides a recording medium set, an image recording apparatus and an image recording method that allow an operator to view all images and to find out the location of a desired image easily, without having to replace the recording media, by using an index disk containing information on the locations of all thumbnails and images, when viewing and using a plurality of images divided and recorded on a plurality of recording media.

1. A compilation recording medium comprising plural sets of thumbnail data and storage information, wherein the plural sets of thumbnail data corresponds with the raw image data of plural photography image data recording medium stored by a storage area of an image data recording apparatus, and storage information includes information about the place where the raw image data was stored, and the plural sets of thumbnail data and the storage information are recorded in relation to mutual.

2. An image data recording apparatus comprising:
an image data recording device to record a plurality of image data sets on the plural raw image data recording medium;
a storage device to store the plural sets of thumbnail data and storage information on a storage area, wherein the plural sets of thumbnail data corresponds with the raw image data of plural raw image data recording medium stored, and storage information includes information about the place where the raw image data was stored, and
a storage data recording device to record the plural sets of thumbnail data and the storage information are recorded on a compilation recording medium in relation to mutual.

3. The image data recording apparatus of claim 2, further comprising of;
a capacity acquisition device to obtained capacity information of the raw image data recording medium for recording a plurality of raw image data, wherein the image data recording device determines the capacity of image data to be recorded for each recording medium based on the capacity information obtained in the capacity acquisition device.

4. The image data recording apparatus of claim 3, wherein the capacity acquisition device obtains the capacity information of the raw image data recording medium by detecting the capacity of the first raw image data recording medium from a plurality of raw image data recording medium.

5. The image data recording apparatus of claim 3, wherein the capacity acquisition device obtains the capacity information of the raw image data recording medium by accepting the operator settings.

6. The image data recording apparatus of claim 2, wherein the image data recording device contains an ID recording device which records the ID information assigned to each raw image data recording medium on the compilation recording medium, and the storage information contains the ID information.

7. An image data recording method, comprising steps of;
recording a plurality of image data sets on the plural raw image data recording medium;
storing the plural sets of thumbnail data and storage information on a storage area, wherein the plural sets of thumbnail data corresponds with the raw image data of plural raw image data recording medium stored, and storage information includes information about the place where the raw image data was stored, and
recording the plural sets of thumbnail data and the storage information are recorded on a compilation recording medium in relation to mutual.

8. The image data recording method of claim 7, further comprising step of;
obtaining capacity information of the raw image data recording medium for recording a plurality of image data, wherein the image data recording step determines the capacity of image data to be recorded for each the raw image data recording medium, based on the capacity information obtained in the capacity acquisition step.

9. The image data recording method of claim 8, wherein the capacity acquisition step obtains the capacity information of the raw image data recording medium by detecting the capacity of the first raw image data recording medium from a plurality of raw image data recording medium.

10. The image data recording method of claim 8, wherein the capacity acquisition step obtains the capacity information of the raw image data recording medium by accepting the operator settings.

11. The image data recording method of claim 7, wherein the image data recording step contains an ID recording step which records the ID information assigned to each raw image data recording medium on the compilation recording medium, and the storage information contains the ID information.

12. An image forming system comprising:
An image data recording apparatus comprising:
an image data recording device to record a plurality of image data sets on the plural raw image data recording medium;
a storage device to store the plural sets of thumbnail data and storage information on a storage area, wherein the plural sets of thumbnail data corresponds with the raw image data of plural raw image data recording medium stored, and storage information includes information about the place where the raw image data was stored,
a storage data recording device to record the plural sets of thumbnail data and the storage information are recorded on a compilation recording medium in relation to mutual; and
an image forming apparatus comprising:
a reading device to read the plural sets of thumbnail data and storage information recorded on the compilation recording medium,
a displaying device to display the read plural sets of thumbnail data;
a selecting device to select a request image data from the displayed plural sets of thumbnail data,
a designating device to designate the raw image data recording medium with which selected image data was recorded from a plurality of raw image data recording medium recorded, based on the selected plural sets of thumbnail data and storage information,
a image data reading device to read the raw image data from the designated raw image data recording medium, and
a image printing device to produce a print based on the read raw image data.
